(19) United States
(12) Patent Application Publication
(10) Pub. No.: US 2024/0340679 A1
(43) Pub. Date: Oct. 10, 2024

(54) METHOD AND APPARATUS FOR IDENTIFYING ARTIFICIAL INTELLIGENCE AND MACHINE LEARNING FUNCTIONS/MODELS IN MOBILE COMMUNICATION SYSTEMS

(71) Applicant: Electronics and Telecommunications Research Institute, Daejeon (KR)

(72) Inventors: Han Jun PARK, Daejeon (KR); Yong Jin KWON, Daejeon (KR); An Seok LEE, Daejeon (KR); Heesoo LEE, Daejeon (KR); Yun Joo KIM, Daejeon (KR); Hyun Seo PARK, Daejeon (KR); Jung Bo SON, Daejeon (KR); Yu Ro LEE, Daejeon (KR)

(73) Assignee: Electronics and Telecommunications Research Institute, Daejeon (KR)

(21) Appl. No.: 18/628,095

(22) Filed: Apr. 5, 2024

(30) Foreign Application Priority Data
Apr. 7, 2023 (KR) 10-2023-0046233
May 30, 2023 (KR) 10-2023-0069229
Feb. 8, 2024 (CN) 2024101773994

(51) Int. Cl. H04W 24/10; H04L 41/16; H04W 24/02

(52) U.S. Cl. CPC H04W 24/10; H04L 41/16; H04W 24/02

(57) ABSTRACT

A method of identifying an artificial intelligence (AI)/machine learning (ML) functionality and model supported for mobile communication operated in a mobile communication system including a base station and one or more user equipments (UEs), the method comprising: delivering, from the base station, dataset identification information regarding at least one dataset to the UE; and reporting, by the UE, valid AI/ML-related UE capability for the at least one dataset corresponding to the dataset identification information to the base station.

### CROSS-REFERENCE TO RELATED APPLICATIONS

This application claims priority to Korean Patent Applications No. 10-2023-0046233, filed on Apr. 7, 2023, and No. 10-2023-0069229, filed on May 30, 2023, with the Korean Intellectual Property Office (KIPO), and Chinse Patent Application No 2024101773994, filed Feb. 8, 2024, the entire contents of which are hereby incorporated by reference.

### BACKGROUND

### 1. Technical Field

Example embodiments of the present invention relate in general to a method and apparatus for identifying artificial intelligence and machine learning (hereinafter referred to as AI/ML)-related functions/models in mobile communication systems including a base station and/or a user equipment when supporting functions/models that utilize AI/ML in network nodes such as the base station and/or a user equipment.

### 2. Related Art

Contents described in this section simply provide background information for the present embodiment and do not constitute the related art.

Recently, artificial intelligence (AI) and machine learning (ML) technologies have been achieving brilliant results in image and natural language fields. Thanks to the technological advancement of AI/ML, a study in academia and industry is actively underway in mobile communication fields to apply the AI/ML technologies to mobile communication systems.

For example, in the industry, 3rd Generation Partnership Project (3GPP), which is an international standardization organization, is conducting study to apply the AI/ML technology to an air interface of mobile communication systems targeting a 5G new radio (5G NR) system.

### SUMMARY

The above conventional discussion has unclear definitions and scopes of artificial intelligence and machine learning (AI/ML) functionalities/models, and does not suggest a method of identifying a specific AI/ML functionality/model between a base station and a user equipment (UE).

Example embodiments of the present invention provides a method and apparatus for identifying AI/ML functionalities/models through an AI/ML-related capability reporting procedure and an AI/ML-related model information reporting procedure in mobile communication systems including a base station and one or more UEs when the base station and/or UE may support one or more AI/ML functionalities/models for mobile communication.

Example embodiments of the present invention provides a method of clearly and efficiently identifying and managing an AI/ML functionality/model by sharing dataset identification information trained by the AI/ML functionalities/models, in a process of identifying and managing valid AI/ML functionalities/models between a base station and a UE.

Example embodiments of the present invention provide a method of efficiently identifying and managing an AI/ML functionality/model by setting the (maximum) number of AI/ML models to be operated for a specific functionality between a base station and a UE and selectively applying one of two or more LCM techniques based on the (maximum) number of AI/ML models.

According to an exemplary embodiment of the present disclosure, a method of identifying an artificial intelligence (AI)/machine learning (ML) functionality and model supported for mobile communication operated in a mobile communication system including a base station and one or more user equipments (UEs), the method may comprise: delivering, from the base station, dataset identification information regarding at least one dataset to the UE; and reporting, by the UE, valid AI/ML-related UE capability for the at least one dataset corresponding to the dataset identification information to the base station.

The delivering of, from the base station, the dataset identification information regarding the at least one dataset to the UE may include requesting, from the base station, AI/ML-related UE capability reporting to the UE.

In the reporting of, by the UE, the valid AI/ML-related UE capability, the UE may report the valid AI/ML-related UE capability for the at least one dataset corresponding to the dataset identification information to the base station in response to the requested AI/ML-related UE capability reporting.

The delivering of, from the base station, the dataset identification information regarding the at least one dataset to the UE may include requesting, from the base station, AI/ML-related UE capability reporting to the UE. The dataset identification information may be delivered by being included in a signal requesting the AI/ML-related UE capability reporting.

The method may further comprise determining, by the UE, validity of AI/ML-related UE capability for the at least one dataset corresponding to the dataset identification information.

In the determining of, by the UE, the validity of the AI/ML-related UE capability, the UE may determine the validity of the AI/ML-related UE capability for at least one of the at least one dataset corresponding to the dataset identification information or a test set corresponding to the at least one dataset based on whether the AI/ML-related UE capability satisfies a predetermined performance criterion.

The dataset identification information may include at least one of scenario information or region information to which the at least one dataset is related.

In the reporting of, by the UE, the valid AI/ML-related UE capability, the AI/ML-related UE capability may include at least one of data collection, model training, model inference operation, model deployment, model activation, model deactivation, model selection, model monitoring, or model transfer.

The method may further comprise: collecting, by the UE, data for a base station-side AI/ML model or network-side AI/ML model; and reporting, by the UE, the collected data to the base station.

The method may further comprise implementing, by the base station, the AI/ML model by classifying and utilizing the collected data for each of identification information regarding the collected data,

In the reporting of, by the UE, the collected data to the base station, at least one of the dataset identification information, UE provider identification information, or functionality identification information may be reported as the identification information regarding the collected data along with the collected data.

According to another exemplary embodiment of the present disclosure, a mobile communication system using an artificial intelligence (AI)/machine learning (ML) functionality and model, comprising a base station and one or more user equipments (UEs), the base station may be configured to set a number of AI/ML models to be operated for a specific functionality to the UE, and the UE may be configured to report information regarding supportable AI/ML models less than or equal to the set number.

In the mobile communication system, when the set number is 1 and the UE reports information regarding the supportable AI/ML models, the UE may report whether to support the specific functionality.

In the mobile communication system, when the set number is 2 or more and the UE reports the information regarding the supportable AI/ML models, the UE may report both a functionality identifier corresponding to the specific functionality and at least one AI/ML model identifier corresponding to the specific functionality.

In the mobile communication system, the base station and the UE may perform a life cycle management (LCM) operation of the AI/ML functionality and model using an operation technique determined based on the set number.

In the mobile communication system, when the set number is 1, a function-based LCM technique may be applied.

In the mobile communication system, when the set number is 2 or more, the model identifier-based LCM technique may be applied.

According to another exemplary embodiment of the present disclosure, a method of identifying artificial intelligence (AI)/machine learning (ML) functionality and model supported for mobile communication operated in a mobile communication system including a base station and one or more user equipments (UEs), the method may comprise: setting, by the base station, a number N of AI/ML models to be operated for a specific functionality to the UE; pre-allocating, by the base station, at least one of model identifiers or order information for N AI/ML models to be operated for the specific functionality; and reporting, by the UE, information regarding supportable AI/ML models less than or equal to N based on the at least one of the pre-allocated model-ID or the order information.

The method may further comprise: determining, by the base station, whether to provide an AI/ML model to the UE in response to a part or all of the at least one of the pre-allocated model identifiers or the order information; and determining, by the base station, whether to report the information regarding the supportable AI/ML models of the UE in response to the at least one of the pre-allocated model identifiers or the order information.

The method may further comprise providing, by the base station, a condition of an AI/ML model to be operated to the UE in response to the at least one of the pre-allocated model identifiers or the order information.

In reporting, by the UE, the information regarding the supportable AI/ML models, whether to support the at least one of the pre-allocated model-ID or the order information may be included in the information regarding the AI/ML model and reported.

The method may further comprise providing, by the base station, a condition of an AI/ML model to be operated to the UE, wherein the condition of the AI/ML model may include at least one of identification information, dataset identification information, or network configuration information regarding the base station-side model or network-side model paired with the UE.

The method may further comprise: setting, by the base station, a local model identifier; and reporting, by the UE, a global model identifier.

When the base station first sets the local model identifier, and the UE may report the global model identifier corresponding to the local model identifier.

When the UE first reports the global model identifier, the base station may set the local model identifier corresponding to the global model identifier.

The method may further comprise: transmitting, from the base station, a model identifier change request signal including a first model identifier and a second model identifier to the UE; updating, by the UE, a model identifier corresponding to the first model identifier to the second model identifier based on the model identifier change request signal; and when the UE does not have a model identifier corresponding to the first model identifier, feeding back an absence of the model identifier corresponding to the first model identifier to the base station.

### BRIEF DESCRIPTION OF DRAWINGS

FIG. 1 is a conceptual diagram illustrating a process of reporting AI/ML-related UE capabilities according to dataset identification information according to an embodiment of the present invention.

FIG. 2 is a conceptual diagram illustrating a configuration of a base station-side or network-side dataset depending on identification information according to an embodiment of the present invention.

FIG. 3 is a conceptual diagram illustrating a multiple AI/ML model information reporting process according to an embodiment of the present invention.

FIGS. 4 and 5 are conceptual diagrams illustrating an LCM operation according to setting the number of operational AI/ML models according to an embodiment of the present invention.

FIG. 6 is a conceptual diagram illustrating the process of delivering the AI/ML model conditions of the base station and reporting the model information of the UE according to an embodiment of the present invention.

FIG. 7 is a conceptual diagram illustrating an AI/ML framework according to an embodiment of the present disclosure.

FIG. 8 is a conceptual diagram illustrating an example of a generalized computing system in which a base station and/or a UE in mobile communication systems capable of performing at least part of the processes of FIGS. 1 to 7 are implemented.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system or a memory system to which embodiments according to the present disclosure are applied will be described. The communication system or memory system to which the embodiments according to the present disclosure are applied is not limited to the content described below, and the embodiments according to the present disclosure can be applied to various communication systems. Here, a communication system may be used in the same sense as a communication network.

Meanwhile, even a technology known before the filing date of the present application may be included as a part of the configuration of the present disclosure when necessary, and will be described herein without obscuring the spirit of the present disclosure. However, in describing the configuration of the present disclosure, the detailed description of a technology known before the filing date of the present application that those of ordinary skill in the art can clearly understand may obscure the spirit of the present disclosure, and thus a detailed description of the related art will be omitted.

For example, as technologies for training specific channel environments using artificial intelligence (AI)/machine learning (ML), training/inferring communication parameters, and the like, technologies known before the application of the present invention may be used, and at least some of these known techniques may be applied as elemental techniques necessary for practicing the present invention.

However, the purpose of the present invention is not to claim rights to these known technologies, and the contents of the known technologies may be included as part of the present invention within the scope without departing from the spirit of the present invention.

Hereinafter, exemplary embodiments of the present invention will be described in more detail with reference to the attached drawings. In order to facilitate overall understanding when describing the present invention, the same reference numerals are used for the same components in the drawings, and duplicate descriptions for the same components are omitted.

Recently, the AI/ML technologies have been achieving brilliant results in image and natural language fields. Thanks to the technological advancement of AI/ML, a study in academia and industry is actively underway in mobile communication fields to apply the AI/ML technologies to mobile communication systems. For example, in the industry, 3rd Generation Partnership Project (3GPP), which is an international standardization organization, is conducting a study to apply the AI/ML technology to an air interface of mobile communication systems targeting a 5G new radio (5G NR) system. The study considers the following three use cases as representative cases.
(1) AI/ML-based channel state information (CSI) feedback
(2) AI/ML-based beam management
(3) AI/ML-based positioning

First, the CSI feedback refers to a process where a user equipment (UE) reports the CSI to a network to help with precoding decision, and the like in a multiple input multiple output (MIMO) system, and in the AI/ML-based CSI feedback, CSI compression, a use case that increases a compression rate of the channel state information by applying the AI/ML technology, and CSI prediction, a use case that predicts the CSI at a future point in time by applying the AI/ML technology, are being discussed. Second, the beam management refers to a process of allocating transmission beam and/or reception beam resources when applying an analog beam using a spatial filter, and in the AI/ML-based beam management, the beam prediction, a use case for predicting beams of unobserved resources in the spatial or temporal domain by applying the AI/ML technology, is being discussed. Third, the positioning refers to a technique for measuring a position of UE, and in the AI/ML-based positioning, AI/ML assisted positioning, a use case that improves the accuracy of conventional positioning techniques by applying the AI/ML technology and direct AI/ML positioning, a use case that directly estimates a position of UE by applying the AI/ML technology, are being discussed.

Since the AI/ML technology is based on training data, life cycle management (hereinafter, LCM) for creation, maintenance, and the like of AI/ML models according to a change in training data should be able to be performed. Therefore, when applying functionality (hereinafter referred to as AI/ML function) based on AI/ML technology in mobile communication systems including a base station (gNodeB (gNB) and/or UE as in the above use cases, the mobile communication systems should be able to support the LCM. In this regard, in the 3GPP, as the detailed operations of the LCM process, data collection, model training, model inference operation, model deployment, model activation, model deactivation, model selection, model monitoring, model transfer, and the like are being discussed. For example, in the mobile communication systems, specific AI/ML models may be managed through the LCM such as data collection→model training→model deployment→model activation→model inference operation→model monitoring.

Meanwhile, before performing the LCM on AI/ML functionalities/models in the mobile communication systems, the AI/ML function(s)/model(s) supported within the network should first be able to be identified. For example, the gNB may instruct the UE to identify which of the AI/ML functionalities/models may be supported and activation, etc., of specific AI/ML functionalities/models at a UE side based on the identified AI/ML functionalities/models. Regarding the identification of the AI/ML functionalities/models, the following two LCM directions are being discussed in next-generation mobile communication technologies including 3GPP.
(1) Model-identifier (model-ID)-based LCM
(2) Function-based LCM

First, the model-ID-based LCM refers to an LCM process in which the gNB (or gNB-side server) and the UE (or UE-side server) share AI/ML model information with the model-IDs in advance, and then the AI/ML models are identified and managed through the model-IDs, etc., between the gNB and the UE. Second, the function-based LCM refers to an LCM process in which the gNB (or gNB-side server) and the UE (or UE-side server) share functionality information for the AI/ML functionality in advance, and then the gNB and the UE identify and manage the AI/ML functionality through a functionality name (or functionality ID), and the like. The present invention relates to a method and apparatus for identifying AI/ML-related functionalities/models.

Embodiments of the present invention and features according to the embodiments are illustratively listed as follows.

First, according to an embodiment of the present invention, in the mobile communication systems including a gNB and one or more UEs, when the gNB and/or UE support one or more AI/ML functionalities/models for mobile communication, a method is provided in which the gNB delivers dataset identification information regarding one or more datasets to the UE and the UE reports valid AI/ML-related UE capabilities for the dataset(s) corresponding to the dataset identification information to the gNB. According to an embodiment of the present invention, when reporting the AI/ML-related UE capabilities, the UE can only report the valid AI/ML-related UE capabilities for the dataset(s) presented by the gNB and greatly increase the signaling efficiency in the UE capability reporting procedure. In addition, the gNB can identify the AI/ML-related configurations that the UE can support through the AI/ML-related UE capabilities of the UE.

Second, in the mobile communication systems including a gNB and one or more UEs according to the embodiment of the present invention, when the UE collects gNB (or network)-side AI/ML training data and reports the collected gNB (or network)-side AI/ML training data to the gNB, a method of reporting gNB (or network)-side AI/ML training data including identification information, such as UE provider information, to the gNB is proposed. According to an embodiment of the present invention, the UE may collect and report the gNB (or network)-side AI/ML training data, and deliver the identification information when reporting the collected data to the gNB (or network).

For example, when reporting the collected data, the UE may also notify from which UE provider's UE the data is collected. According to the embodiment, the gNB may support the AI/ML models specialized for each UE provider by training the gNB (or network)-side AI/ML model with the data for each UE provider. Therefore, according to the embodiment of the present invention, it is possible to help classify and utilize the training data of the gNB (or network)-side AI/ML models more efficiently.

Third, in the mobile communication systems including a gNB and one or more UEs according to the embodiment of the present invention, when the UE may report one or more pieces of AI/ML model information regarding a specific functionality to the gNB and the gNB may set the (maximum) number of AI/ML models to be operated for the specific functionality to the UE as N numbers, a method of applying different life cycle management (hereinafter, referred to as LCM) operations of AI/ML functionalities/models as follows depending on values of the N is proposed. Specifically, a method of applying function-based LCM when N=1 and applying model-identifier (model-ID)-based LCM when N>1 is proposed. According to an embodiment of the present invention, a gNB (or network) may select an exemplary LCM method by controlling the (maximum) number of AI/ML models to be operated. For example, when the gNB determines that it is sufficient to operate only a single model for a specific function, the (maximum) number of AI/ML models to be operated may be set to 1 and the function-based LCM may be applied to the corresponding function. On the other hand, when the gNB determines that the plurality of models are required for a specific function, the (maximum) number of AI/ML models to be operated may be set to greater than 1 and the model-ID-based LCM may be applied to the corresponding function. As a result, it is possible for the gNB (or network) to select the exemplary LCM methods for each AI/ML function.

Fourth, in the mobile communication systems including a gNB and one or more UEs according to the embodiment of the present invention, when the UE may report one or more pieces of AI/ML model information regarding the specific functionality to the gNB and the gNB may set the (maximum) number of AI/ML models to be operated for the specific functionality to the UE as N numbers, a method is proposed in which the gNB pre-allocates model-ID (or order) information regarding the N AI/ML model(s) and the UE reports to which model-ID (or order) information the corresponding model information corresponds when reporting the model information. According to the embodiment of the present invention, it is possible for the gNB to quickly perform the procedure for assigning the model-ID before receiving a report on the model information of the UE. In addition, it is possible to easily identify, from the model-ID corresponding to the model information that the UE reports, the model information regarding which operating conditions the AI/ML models correspond to.

Hereinafter, for convenience of description, the artificial neural network learning and configuration method proposed in the present invention will be mainly described from a downlink perspective of a wireless mobile communication system including a gNB and UE. However, the embodiments of the proposed method of the present invention may be extended and applied to any wireless mobile communication systems including a transmitter and a receiver. Hereinafter, the gNB may represent the network including the gNB. In addition, according to the present invention, for convenience of description, the types of AI/ML models are divided as follows depending on the location of the network node where the inference operation is performed.

### One-Sided AI/ML Model

AI/ML model where inference is performed in only the UE or gNB (or network).
When the inference is performed in only the UE, it is divided into a UE-sided

AI/ML model, and when the inference is performed in only the gNB (network), it is classified into a network-sided AI/ML model.

### Two-Sided AI/ML Model

Paired AI/ML model(s) on which common inference is performed.
Common inference means the AI/ML inference in which the inference is performed jointly across the UE and network (or network).
For example, when a first part of the inference is performed by the UE and the remaining part is performed by the gNB, or vice versa.
Among two-sided AI/ML models, a part that performs inference in the UE is divided into a terminal part (e.g., UE part), and a part that performs inference in the gNB is classified into a gNB (or network) part (e.g., NW part).

### [AI/ML-Related Capability Reporting]

### Embodiment 01 of Proposed Method

In mobile communication systems including a base station (gNodeB (gNB)) and one or more user equipments (UEs) according to an embodiment of the present invention, a method is proposed in which the gNB delivers dataset identification information regarding one or more datasets to the UE, and the UE reports valid AI/ML-related UE capabilities for the dataset(s) corresponding to the dataset identification information to the gNB.

Here, the dataset identification information is identification information for dividing scenarios/regions, etc., and the gNB may set the dataset identification information to physical channel and resources received by the UE. The above [Proposed Example 01] may also be established by replacing the dataset identification information with the scenario/region identification information.

Here, the gNB may deliver data set identifier information by including the data set identifier information in UE capability enquiry signaling.

Here, when the UE determines validity of AI/ML-related UE capability for a specific dataset, for the corresponding data set (or test set corresponding to the dataset), when the specific AI/ML-related UE capability satisfies certain performance criterion(s), the AI/ML-related UE capability may be determined to be valid.

Here, the gNB may identify AI/ML functionalities that the UE can support from the UE capability information.

In the mobile communication systems including a gNB and one or more UEs according to the embodiment of the present invention, the gNB (or network) may deliver a UE capability enquiry control signal to the UE for the purpose of determining network settings after identifying the functionalities supported by the UE, and the UE may respond to the control signal with a UE capability information report. The UE capability information is information regarding UE functionalities and represents the functionalities that the UE can support, the network settings supportable for each function, etc. Meanwhile, when the UE possesses the AI/ML-related capabilities, the UE may report the AI/ML-related UE capabilities through the UE capability information reporting process. However, since the AI/ML is a data-based learning function, the AI/ML-related capabilities possessed by the UE may be capability information regarding one or more datasets. Additionally, since the dataset may have characteristics that are divided for each scenario/region, the AI/ML-related capabilities possessed by the UE may be as diverse as the number of scenarios/regions supported. Therefore, when the AI/ML-related UE capabilities are reported without separate filtering or constraints, the amount of capability information that the UE should report to the gNB can be excessive, and such vast capability information can reduce the usability of the gNB.

For example, it is assumed that the UE reports UE-side AI/ML model information as the UE capability. Since the UE-side AI/ML model (or dataset for AI/ML model learning) is affected by various factors such as operating frequency, orthogonal frequency division multiplexing (OFDM) parameters, network settings, a network vendor, and UE-side version management, there may be a very large number of AI/ML models corresponding to a very large number of cases. In this way, the number of various environmental conditions and cases that affect the AI/ML models cause the gNB to allocate many uplink resources when reporting the AI/ML model information in the UE capability reporting process, while the AI/ML model information corresponding to the network settings that the gNB actually wishes to operate AI/ML model information is limited, so resources may be used inefficiently. In addition, from the gNB operation perspective, the vast AI/ML-related UE capabilities reported by the UE should be confirmed one by one, so the gNB may unnecessarily search for the AI/ML model information corresponding to the network settings that the gNB will not be supported. To report the UE capability reporting more efficiently, the present invention provides the method of delivering, from the gNB, dataset identification information regarding one or more datasets to the UE, and reporting, by the UE, valid AI/ML-related UE capabilities for the dataset(s) corresponding to the dataset identification information to the gNB. Specifically, in the mobile communication systems including a gNB and one or more UEs according to the embodiment of the present invention, the gNB may deliver the identification (or scenario/region identification) information regarding one or more datasets to the UE through the UE Capability enquiry signal. The UE may report, to the gNB, the valid AI/ML-related UE capabilities for the dataset (or scenario/region) (s) corresponding to the dataset identification (or scenario/region identification) information. The valid AI/ML refers that the AI/ML functionalities/models meet the reference performance for the test set corresponding to the corresponding dataset (or scenario/region).

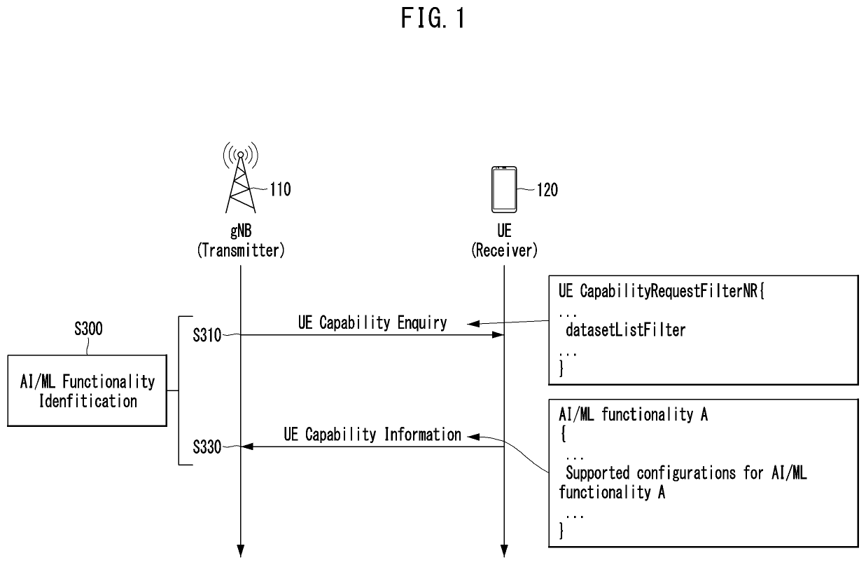

FIG. 1 is a conceptual diagram illustrating a process of reporting AI/ML-related UE capabilities according to dataset identification information according to an embodiment of the present invention.

Referring to FIG. 1, when delivering the UE capability enquiry to a UE 120, the gNB (or a base station) 110 may deliver the UE capability enquiry including the dataset list information for filtering the UE capabilities (S310). For example, in FIG. 1, the dataset list for filtering the UE capabilities may be delivered like a datasetListFilter item in a UE-CapabilityRequestFilterNR item in the UE capability enquiry. Thereafter, the UE 120 may report the valid AI/ML functionality information after filtering the UE capabilities into the dataset list delivered by the gNB (S330). For example, in FIG. 1, the UE 120 may report supportable configuration information regarding AI/ML functionality A item. An operation S310 of delivering the UE capability enquiry from the gNB 110 to the UE 120 (S310) and an operation S330 of reporting the UE capability information from the UE 120 to the gNB 110 may configure an operation S300 of identifying the AI/ML functionalities.

The above [Embodiment 01 of Proposed Method] may be applied along with other embodiment(s) of proposed method of the present invention within the range that it does not conflict with Embodiment 01 of Proposed Method.

### Embodiment 02 of Proposed Method

In mobile communication systems including a gNB and one or more UEs according to the embodiment of the present invention, when the UE reports the AI/ML-related UE capabilities to the gNB, a method of reporting capability information including one or more of the following capability information.

### (1) Regarding Data Collection

A. Data collection/report capabilities for training/performance monitoring for UE-side AI/ML models
B. Collection/reporting capabilities for training/performance monitoring for gNB (network)-side AI/ML models
C. Data collection/reporting capabilities for training/performance monitoring for UE part of two-sided AI/ML models
D. Data collection/reporting capabilities for training/performance monitoring for gNB (network) part of two-sided AI/ML models

### (2) Regarding Model Learning

A. Online/offline learning capabilities for UE-side AI/ML models
B. Online/offline learning capabilities for gNB (network)-side AI/ML models
C. Online/offline learning capabilities for UE part of two-sided AI/ML models
D. Online/offline learning capabilities for gNB (network) part of two-sided AI/ML models

### (3) Regarding Inference Operation

A. UE-side AI/ML model support/reporting capabilities
B. gNB (network)-side AI/ML model support/reporting capabilities
C. UE-side AI/ML model download capabilities
D. UE part support/reporting capabilities among two-sided AI/ML models
E. gNB (network) part support/reporting capabilities among two-sided AI/ML models
F. UE part download capability among two-sided AI/ML model

### (4) Regarding Model Activation/Deactivation

A. (Network-based) UE-side AI/ML model activation/deactivation support capabilities
B. (UE-based) UE-side AI/ML model activation/deactivation support capabilities
C. (Network-based) two-sided AI/ML model activation/deactivation support capabilities
D. (UE-based) two-sided AI/ML model activation/deactivation support capabilities

### (5) Regarding Model Selection

A. Multiple AI/ML model support capabilities for UE-side AI/ML models
B. Multiple AI/ML model support capabilities for gNB (network)-side AI/ML models
C. Multiple AI/ML model support capabilities for UE part of two-sided AI/ML models
D. Multiple AI/ML model support capabilities for gNB (network) part of two-sided AI/ML models

### (6) Regarding Model Monitoring

A. UE-side AI/ML model performance monitoring/reporting capabilities
B. gNB-side AI/ML model performance monitoring/reporting capabilities
C. Performance monitoring/reporting capabilities for UE part of two-sided AI/ML models
D. Performance monitoring/reporting capabilities for gNB part of two-sided AI/ML models

### (7) Regarding Model Transfer

A. gNB (network)-side AI/ML model transfer capabilities
B. Model transfer capabilities for gNB (network) part of two-sided AI/ML models

Here, the UE-side AI/ML model support/reporting capabilities refers to the capabilities that may support and/or report the AI/ML models that are trained in the UE or UE server and perform the inference operation in the UE. In addition, the UE-side AI/ML model download support capabilities refer to the capability that may support an operation of downloading and applying, by the UE, the AI/ML models that are trained in the gNB or gNB server and perform the inference operation in the UE.

Here, the AI/ML-related UE capabilities may be reported for each AI/ML function.

In the mobile communication systems including a gNB and one or more UEs according to the embodiment of the present invention, the gNB (or network) may deliver a UE capability enquiry control signal to the UE for the purpose of determining network configuration after identifying the functionalities supported by the UE, and the UE may respond to the control signal with a UE capability information report. The UE capability information is information regarding UE functionalities and represents the functionalities that the UE can support, the network settings supportable for each function, etc. Meanwhile, when the UE has the AI/ML-related capabilities, the UE may report the AI/ML-related UE capabilities through the UE capability information reporting process. The AI/ML-related UE capability information may include the UE capabilities for each operation of the LCM process. For example, the AI/ML-related UE capability information may include the above-described capability elements in response to LCM elements such as data collection, model training, model inference operation using a model, model deployment, model activation, model deactivation, model selection, model monitoring, and/or model transfer.

For example, the UE A may only support the data collection-related capabilities, and may not support the AI/ML model-related capabilities. The UE A may not use the AI/ML functionalities/models, but support the data collection for use of the UE-side AI/ML models in other UEs and/or data collection for use of the gNB-side AI/ML models, etc. In addition, when the UE trains the gNB (or network) part of the gNB-side AI/ML models or two-sided AI/ML models and delivers the corresponding models to the gNB (or network), the UE may possess the gNB (or network) part-related UE capabilities of the gNB-side AI/ML models or two-sided AI/ML models and report the possessed gNB part-related UE capabilities to the gNB.

The above [Embodiment 02 of Proposed Method] may be applied along with other embodiments(s) of proposed method of the present invention within the range that it does not conflict with Embodiment 02 of Proposed Method.

### Embodiment 03 of Proposed Method

In the mobile communication systems including a gNB and one or more UEs according to the embodiment of the present invention, when the UE collects gNB (or network)-side AI/ML training data and reports the collected gNB (or network)-side AI/ML training data to the gNB, a method of reporting the gNB (or network)-side AI/ML training data including one or more of the following identification information, is proposed.
(1) Dataset Identification Information
(2) UE Provider Identification Information
(3) Functionality Identification Information

Here, the dataset identification information is identification information for dividing scenarios/regions, etc., and the gNB may set the dataset identification information to physical channel and resources received by the UE. The proposed invention may also be established by replacing the dataset identification information with the scenario/region identification information.

Here, the gNB may divide the gNB (or network)-side AI/ML training data for each of identification information and train and implement the gNB (or network)-side AI/ML models for each of identification information. For example, after dividing the data collected from the UE for each UE provider, the gNB (or network)-side AI/ML models specialized for each UE provider may be trained and implemented.

In the mobile communication systems including a gNB and one or more UEs according to the embodiment of the present invention, it is assumed that the UE may collect the AI/ML training data and report the collected AI/ML training data to the gNB (or network). In this case, the gNB (or network) should be able to classify the data collected by the UE into the dataset that is easy to train. Therefore, the present invention provides the method in which the UE collects gNB (or network) AI/ML training data and reports the collected gNB (or network) AI/ML training data to the gNB, including identification information of one or more of the three types of information described above.

For example, when the gNB receives the gNB (or network)-side AI/ML training data from the UE, the gNB may identify from which UE provider the corresponding UE is provided, and divide the gNB (or network)-side AI/ML training data for each UE provider. In addition, the UE may deliver information identifying which functionality the gNB (or network)-side AI/ML training data transmitted from the UE is for. In the above case, the gNB can use both the functionality identification information and UE provider identification information to configure datasets for each functionality and each UE provider. Alternatively, when the gNB sets dataset identification information regarding a specific measurement resource to the UE, the UE may expect that data measured with the corresponding measurement resource will be managed with the dataset identification information. Therefore, when the dataset identification information is set for the specific measurement resource, the UE may report the dataset identification information together when reporting the gNB (or network)-side AI/ML training data measured with the corresponding measurement resource to the gNB.

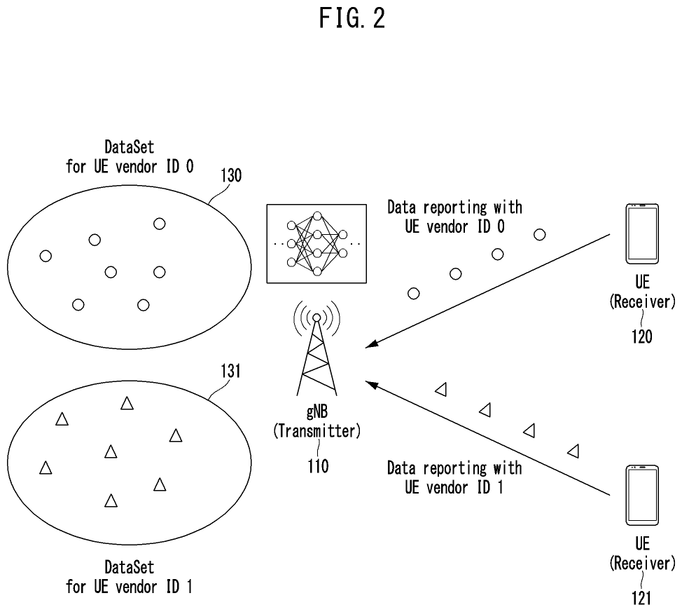

FIG. 2 is a conceptual diagram illustrating a configuration of a gNB (a base station)-side or network-side dataset depending on identification information according to an embodiment of the present invention.

Referring to FIG. 2, UEs 120 and 121 may collect data for AI/ML models of a gNB 110 (or network) and report the collected data to the gNB 110 (or network), and deliver UE provider (e.g., UE vendor ID) information together when reporting the data. After receiving the data reported by the UEs 120 and 121, the gNB 110 (or network) may classify datasets 130 and 131 according to the UE provider information, and may then be used to train the gNB 110 (or network)-side AI/ML model.

That is, the first dataset 130 identified by the UE provider information reported by the first UE 120 may be classified and managed separately from the second dataset 131 identified by the UE provider information reported by the second UE 121, and the gNB 110 (or network) may identify and manage the AI/ML models and datasets 130 and 131 so that the AI/ML models based on different datasets 130 and 131 are applied to each of the different UEs 120 and 121.

The above [Embodiment 03 of Proposed Method] may be applied along with other embodiment(s) of proposed method of the present invention within the range that it does not conflict with Embodiment 03 of Proposed Method.

### [AI/ML-Related Model Reporting]

### Embodiment 04 of Proposed Method

In mobile communication systems including a gNB and one or more UEs according to an embodiment of the present invention, when the UE may report one or more pieces of AI/ML model information regarding a specific functionality to the gNB, a method is proposed in which the gNB sets the (maximum) number of AI/ML models to be operated for the specific functionality to the UE and the UE reports the model information regarding the supportable AI/ML model(s) smaller than or equal to the (maximum) number to the gNB.

Here, when the maximum number of AI/ML models to be operated for the specific functionality is 1, the UE may replace the supportable AI/ML model information reporting with reporting whether to support the corresponding function.

In the mobile communication systems including a gNB and one or more UEs according to the embodiment of the present invention, it is assumed that the UE may report the AI/ML model information supported for the specific functionality to the gNB. Meanwhile, when using the AI/ML models for the specific function, it may be preferable to use the plurality of AI/ML models.

For example, the UE may configure the plurality of AI/ML models trained on the plurality of datasets or scenarios/regions to support the UE-side AI/ML-based functionalities. The gNB may currently identify the valid dataset or scenario/region for the UE and then activate the AI/ML models appropriate for the corresponding dataset or scenario/region. As another example, the UE may support one or more AI/ML parts that operate at the UE side among the two-sided AI/ML model. More specifically, when performing CSI feedback using the AI/ML, the two-sided AI/ML models may be composed of an AI/ML-based encoder operating in the UE and an AI/ML-based decoder operating in the gNB. In this case, the UE may support the plurality of AI/ML-based encoders (i.e., the plurality of AI/ML models) corresponding to each CSI payload to support a plurality of CSI payload sizes. However, even when the UE may support the plurality of AI/ML models for the specific function, it may be preferable that the gNB is supported within the operable range for the corresponding function. For example, in the example of the CSI feedback, when the gNB is not willing to change the CSI payload size, the UE does not need to report the plurality of AI/ML model information to the gNB. Therefore, in the mobile communication systems including a gNB and one or more UEs according to the embodiment of the present invention, when the UE may report one or more pieces of AI/ML model information regarding a specific functionality to the gNB, a method is proposed in which the gNB sets the (maximum) number of AI/ML models to be operated for the specific functionality to the UE and the UE reports the model information regarding the supportable AI/ML model(s) smaller than or equal to the (maximum) number to the gNB. That is, the gNB may have a control right for the maximum number of AI/ML model(s) that the UE may report.

In this case, when the maximum number of AI/ML models to be operated for the specific functionality is 1, the UE may replace the supportable AI/ML model information reporting with reporting whether to support the corresponding function. Here, limiting the maximum number of AI/ML models to be operated for the specific functionality to 1 may refer that the gNB is not involved in selecting the AI/ML model for the corresponding function.

For example, even when the UE actually has the plurality of AI/ML models and operates by changing the AI/ML model for the specific function, the gNB does not recognize such UE operation and implementation. On the other hand, setting the maximum number of AI/ML models to be operated for the specific functionality to two or more implies that the gNB has room to be involved in model selection. For example, when the gNB sets the maximum number of AI/ML models to be operated for the specific functionality to the UE as 2 and the UE reports information regarding two AI/ML models to the UE, the gNB may selectively activate one of the AI/ML models depending on the operating conditions and/or performance.

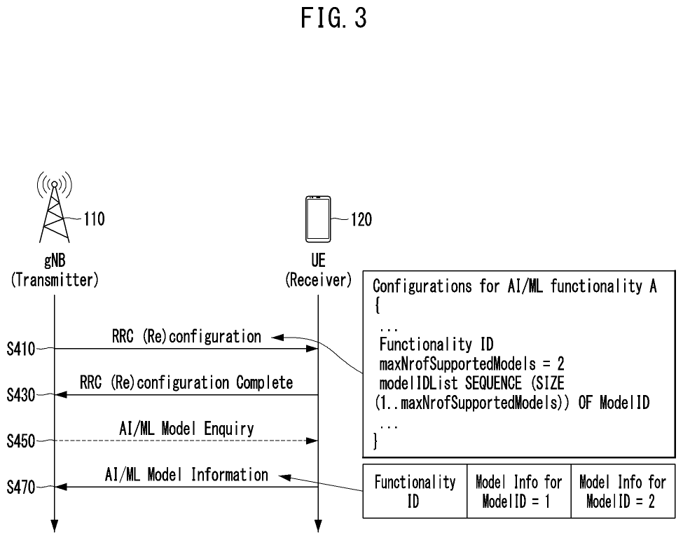

FIG. 3 is a conceptual diagram illustrating a multiple AI/ML model information reporting process according to an embodiment of the present invention.

Referring to FIG. 3, when the gNB (or base station) 110 delivers the configuration information regarding the AI/ML functionality to the UE 120 (S410), the gNB may deliver the information regarding the number of AI/ML models (e.g., maxNrofSupportedModels) to be supported by the corresponding AI/ML functionality information together. Thereafter, the UE 120 may report the information regarding the AI/ML models smaller than or equal to the set number of AI/ML models to the gNB (S470). FIG. 3 illustrates an embodiment where the gNB 110 is set to support two AI/ML models for the AI/ML functionality A. In addition, FIG. 3 illustrates an embodiment in which the UE 120 reports two pieces of AI/ML model information corresponding to configuration information regarding the AI/ML functionality received from the gNB 110.

The UE 120 may respond that it has received configuration information (RRC (Re) configuration) for the AI/ML functionality received in operation S410 (S430). After the gNB 110 responds that the UE 120 has received the configuration information regarding the AI/ML function, when a predetermined condition is met, the gNB 110 may deliver the inquiry/enquiry of the AI/ML models to the UE 120. The UE 120 may answer the AI/ML model information corresponding to the functionality IDs and model-IDs in response to the enquiry in operation S450 (S470).

The predetermined condition under which operation S450 is performed may be a condition in which the predetermined time has elapsed after operation S430 or the situation requiring the application of the AI/ML models has arrived. In addition, according to another embodiment of the present invention, operations S430 and S450 may be omitted or replaced with another protocol between the gNB 110 and the UE 120.

The above [Embodiment 04 of Proposed Method] may be applied along with other embodiments(s) of proposed method of the present invention within the range that it does not conflict with Embodiment 04 of Proposed Method.

### Embodiment 05 of Proposed Method

In the mobile communication systems including a gNB and one or more UEs according to the embodiment of the present invention, when the UE may report one or more pieces of AI/ML model information regarding a specific functionality to the gNB and the gNB may set the (maximum) number of AI/ML models to be operated for the specific functionality to the UE as N numbers, a method of applying different life cycle management (hereinafter, referred to as LCM) operations of AI/ML functionalities/models as follows is proposed.

### (1) When N=1

A. Application of function-based LCM

### (2) When N>1

A. Application of model-ID-based LCM

Here, the function-based LCM refers to an LCM process in which the gNB (or gNB-side server) and the UE (or UE-side server) share functionality information for the AI/ML functionality in advance, and then the gNB and the UE identify and manage the AI/ML functionality through a functionality name (or functionality ID), and the like.

Here, the model-ID-based LCM refers to an LCM process in which the gNB (or gNB-side server) and the UE (or UE-side server) share the AI/ML model information with the model-IDs in advance, and then the AI/ML models are identified and managed through the model-IDs, etc., between the gNB and the UE.

Here, when the maximum number of AI/ML models to be operated for the specific functionality is 1, the UE may replace the supportable AI/ML model information reporting with reporting whether to support the corresponding function.

In the mobile communication systems including a gNB and one or more UEs according to the embodiment of the present invention, when the gNB and/or UE supports the AI/ML functionalities/models, two major LCM methods are being considered. Among the two LCM methods, the first method refers to an LCM process in which the gNB (or gNB-side server) and the UE (or UE-side server) share functionality information for the AI/ML functionality in advance based on the function-based LCM, and then the gNB and the UE identify and manage the AI/ML functionality through a functionality name (or functionality ID), and the like. The second method refers to the LCM process in which the gNB (or gNB-side server) and the UE (or UE-side server) share the AI/ML model information along with the model-IDs in advance based on the model-ID-based LCM, and then the AI/ML models are identified and managed through the model-IDs, etc., between the gNB and the UE.

The function-based LCM and model-ID-based LCM each have advantages and disadvantages. First, the function-based LCM has the advantage of simple network operation since it manages the AI/ML functionalities on a functionality basis, but it has the disadvantage of being less adaptable to the environment because it is difficult to select the AI/ML models optimized for performance depending on the scenario, etc.

The model-ID-based LCM has the advantage of enabling more optimized AI/ML model selection and application because it manages the AI/ML functionalities on a model basis, but has the disadvantage in that the network should bear the burden of evaluating and managing the AI/ML models. Since both the methods have advantages and disadvantages, it may be preferable to support both the function-based LCM and model-ID-based LCM depending on the network operator's selection.

Accordingly, in the present invention, when the UE may report one or more pieces of AI/ML model information regarding specific functionality to the gNB and the gNB may set the (maximum) number of AI/ML models to be operated for the specific functionality to the UE as N numbers, a method of applying different life cycle management (hereinafter, referred to as LCM) operations of AI/ML functionalities/models as follows is proposed.

For example, when the gNB sets the (maximum) number of AI/ML models to be operated for the specific functionality to 1, from a logical perspective, only the single AI/ML model may be operated for the corresponding function. Therefore, the gNB does not need to select or evaluate one of several models for the corresponding function, and may apply the function-based LCM. In this case, whether the UE physically implements a plurality of models or a single model for a single logical model depends on the degree of freedom of implementation. On the other hand, when the (maximum) number of AI/ML models to be operated by gNB for the specific functionality is set to 2, the gNB should be able to evaluate and manage the models with better performance among the two AI/ML models for the corresponding functionality and may apply the model-ID-based LCM.

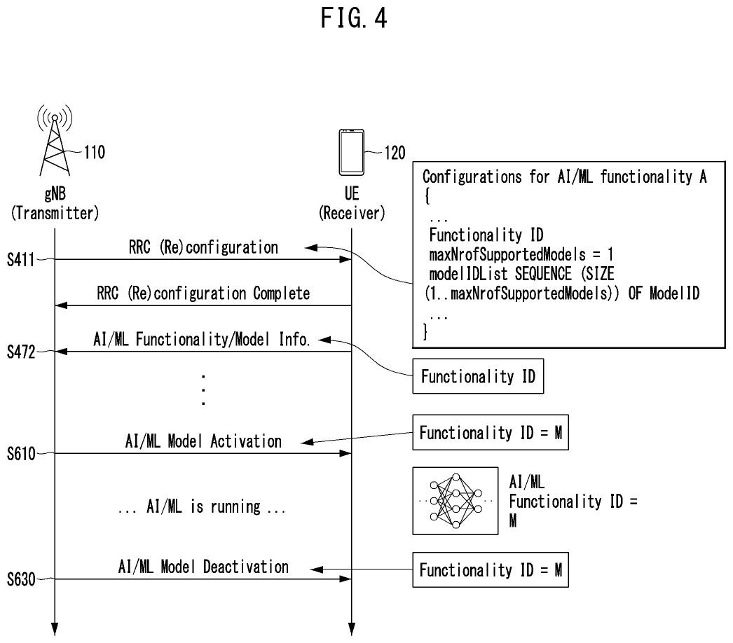

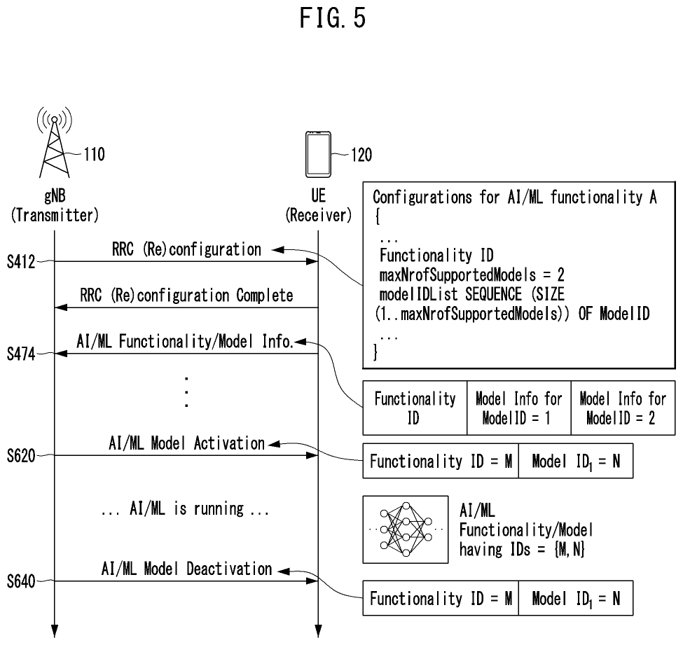

FIGS. 4 and 5 are conceptual diagrams illustrating an LCM operation according to setting the number of operational AI/ML models according to an embodiment of the present invention.

FIG. 4 illustrates an embodiment in which the number of operational AI/ML models is 1, and FIG. 5 illustrates an embodiment in which the number of operational AI/ML models is 2 or more.

Referring to FIGS. 4 and 5, when the gNB (or base station) may deliver the configuration information regarding the AI/ML functionality to the UE, the gNB may deliver the information (e.g., maxNrofSupportedModels) on the number of AI/ML models to be supported by the corresponding AI/ML functionality information together (S411 and S412). Thereafter, the LCM operation may be applied differently depending on the number of AI/ML models to be supported. Specifically, as illustrated in FIG. 4, when the number of operational AI/ML models is 1, the function-based LCM may be applied (S610 and S630), and as illustrated in FIG. 5, when the number of operational AI/ML models is 2 or more, the model-ID-based LCM may be applied (S620 and S640).

As illustrated in FIG. 4, when the number of operational AI/ML models is 1, when the gNB delivers specific AI/ML function-related configuration information to the UE through upper layer signals such as RRC, the number of AI/ML models to be operated for the corresponding AI/ML functionality may be set to 1 and delivered (S411). Thereafter, the UE may report whether the AI/ML functionality can be supported or information regarding supported models (S472). In the embodiment of FIG. 4, assuming that the gNB assigns, for example, the functionality ID to the AI/ML function, the UE may implicitly indicate that it supports the functionality by reporting the functionality ID in response to the AI/ML function-related configuration information (S472). Thereafter, the activation/deactivation instructions for the AI/ML functionality may also be made by the functionality ID for the AI/ML functionality (S610 and S630). That is, the function-based LCM process may be performed.

As illustrated in FIG. 5, when the number of operational AI/ML models is 2 or more, when the gNB delivers specific AI/ML function-related configuration information to the UE through upper layer signals such as RRC, the number of AI/ML models to be operated for the corresponding AI/ML functionality may be set to plural numbers and delivered (S412). Thereafter, the UE may report model information supporting the AI/ML functionality (S474). In the embodiment of FIG. 5, when the gNB delivers the configuration information regarding the AI/ML functionality to the UE, the gNB may deliver the information such as the number of AI/ML models (e.g., maxNrofSupportedModels) to be supported by the corresponding AI/ML function, and a model-ID list (e.g., modelIDList) having the number of AI/ML models as the length (S412). In the embodiment of FIG. 5, the UE may report the model information that the UE can support for each model-ID in response to the AI/ML function-related configuration information (S474). Thereafter, the activation/deactivation instructions for the AI/ML functionality may also be made by the combination of the functionality IDs and model-IDs for the corresponding AI/ML functionality (S620 and S640). That is, the model-ID-based LCM process may be performed.

Referring to the embodiments of FIGS. 4 and 5, in an embodiment of the present invention, the model-ID-based LCM method is disadvantageous in management on a functionality basis when the plurality of functionalities (or settings) are implemented in the single model, but may more effectively provide the LCM by supporting management based on a model basis when the plurality of models are implemented for the single function. That is, the model-ID-based LCM method may be advantageous in view of management based on the model basis rather than on the functionality basis, and may be an advantageous management method when the plurality of models are implemented for the single functionality or when the plurality of models are applicable.

Referring to the embodiment of FIGS. 4 and 5, in one embodiment of the present invention, the function-based LCM method is disadvantageous in view of management based on the model basis when the plurality of models are implemented for the single function, but may more effectively provide the LCM by supporting the management based on the functionality basis when the plurality of functionalities (or settings are implemented in the single model, the single functionality is implemented in the single model, or there is no need to differentiate between the models for the single function. That is, the function-based LCM method may be advantageous in view of management based on the functionality basis rather than the management based on the model basis, and may be an advantageous management method when the plurality of functionalities (or settings) are implemented in the single model, the single functionality is implemented in the single model, or there is no need to differentiate between the models for the single function.

The above [Embodiment 05 of Proposed Method] may be applied along with other embodiment(s) of proposed method of the present invention within the range that it does not conflict with Embodiment 05 of Proposed Method.

### Embodiment 06 of Proposed Method

In mobile communication systems including a gNB and one or more UEs according to an embodiment of the present invention, when the UE may report one or more pieces of AI/ML model information regarding a specific functionality to the gNB and the gNB may set the (maximum) number of AI/ML models to be operated for the specific functionality to the UE as N numbers, a method is proposed in which the gNB pre-allocates to model-ID (or order) information for the N AI/ML model(s).

Here, the UE may pre-allocate the model-IDs (or order) of the gNB and then report the AI/ML model information.

Here, the model-ID (or order) information may be explicitly delivered by the gNB to the UE or determined in a pre-arranged manner between the gNB and the UE without the explicit delivery process.

Here, the gNB may provide the AI/ML models corresponding to a part or all of the model-IDs (or orders) to the UE. When the gNB provides the model, the UE may not report the AI/ML model information regarding the corresponding model-IDs (or order).

Here, the gNB may set whether to report the AI/ML models of the UE for each model-ID (or order).

In the mobile communication systems including a gNB and one or more UEs according to the embodiment of the present invention, it is assumed that the UE may report the AI/ML model information supported for the specific functionality to the gNB. The AI/ML model information may be information regarding one or more AI/ML model(s). Meanwhile, when the UE may report the AI/ML model information to the gNB, and the gNB and the UE wish to recognize the same AI/ML model from each other, the identifiers for the AI/ML models need to be allocated. The identifiers for the AI/ML models reported by the UE may be allocated in two methods. The first is a method in which the UE allocates the identifiers for the AI/ML models and then reports the allocated identifiers to the gNB, and the second is a method in which the gNB allocates the identifiers for the AI/ML models. However, the boundary of the AI/ML models that gNB and UE wish to recognize each other may be determined from a logical perspective.

For example, even when the gNB supports the AI/ML inference operations for the plurality of functionalities by implementing the single AI/ML model in reality, as if there are the AI/ML models separated for each function, the gNB may define the logical AI/ML models and model-IDs. Specifically, even when the UE supports CSI compression and CSI prediction with the single AI/ML model from an implementation perspective, the gNB may be configured as if the AI/ML model for the CSI compression (AI/ML Model A) and the AI/ML model for the CSI prediction (AI/ML model B) exist. From the above perspective, the present invention proposes a specific method in which the gNB allocates the model-IDs when allocating the identifiers for the AI/ML models reported by the UE. First, the gNB may first receive a report on the model information from the UE and then allocate the model-IDs to the corresponding models. When reporting the model information to the gNB, the UE may also report global model-IDs for the AI/ML models together. Thereafter, when the gNB allocates the model-IDs to the UE, the corresponding model-ID may have the meaning of the local model-ID within the area managed by the gNB.

For example, a series of model identification processes may be performed as follows. The gNB may first identify the AI/ML functionalities that the UE can support during the UE capability reporting process and set the AI/ML functionality to be operated by the gNB. Thereafter, the UE may report the supportable model information for each functionality for the set AI/ML functionalities. The model information may include the global model-IDs. The gNB may receive the model information report of the UE and then allocate the model-IDs to each model. The above method has the advantage of being carried out according to a clear procedure, but has the disadvantage that a time delay may occur because the model identification process progresses over several operations. Therefore, in addition to the above method, the present invention proposes a method in which the gNB pre-allocates the model-IDs to the UE. Specifically, when the UE may report one or more AI/ML model information regarding the specific functionality to the gNB, a method is proposed in which the gNB sets the (maximum) number of AI/ML models to be operated for the specific functionality to the UE, and informing the UE of the model-ID (or order) information regarding the models within the (maximum) number of AI/ML models along with the configuration information regarding the (maximum) number.

As an example, referring back to FIG. 3, when the gNB 110 delivers the configuration information regarding the AI/ML functionality to the UE 120 (S410), the gNB may deliver the information regarding the number of AI/ML models (e.g., maxNrofSupportedModels) to be supported by the corresponding AI/ML functionality information together. In addition, in operation S410, the gNB 110 may deliver the model-ID list (e.g., modelIDList) having the number of AI/ML models to be operated by the gNB 110 as the length. The model-ID list may include the model-IDs pre-allocated by the gNB 110, and only when the gNB 110 provides the model for the specific model-ID or when the UE 120 reports the corresponding model information, the gNB 110 and UE 120 may determine that the corresponding model-ID is valid.

The above [Embodiment 06 of Proposed Method] may be applied along with other embodiment(s) of proposed method of the present invention within the range that it does not conflict with Embodiment 06 of Proposed Method.

### Embodiment 07 of Proposed Method

In mobile communication systems including a gNB and one or more UEs according to an embodiment of the present invention, when the UE may report one or more pieces of AI/ML model information regarding a specific functionality to the gNB, the gNB may set the (maximum) number of AI/ML models to be operated for the specific functionality to the UE as N numbers, and model-ID (or order) information regarding the N AI/ML model(s) is allocated, a method of informing the UE of a condition(s) of the AI/ML models to be operated for each model-ID (or order).

Here, the model-ID (or order) information may be explicitly delivered by the gNB to the UE or determined in a pre-arranged manner between the gNB and the UE without the explicit delivery process.

Here, when reporting the AI/ML model information, the UE may report the model information that meets the condition(s) of the AI/ML models for each model-ID (or order). In addition, the UE may deliver to the gNB by including whether to support each model-ID (or order) in the model information.

Here, the gNB may provide the AI/ML models corresponding to a part or all of the model-IDs (or orders) to the UE. When the gNB provides the models, the UE may not report the AI/ML model information regarding the corresponding model-ID (or order).

Here, the gNB may set whether to report the AI/ML models of the UE for each model-ID (or order).

In the mobile communication systems including a gNB and one or more UEs according to the embodiment of the present invention, it is assumed that the UE may report the AI/ML model information supported for the specific functionality to the gNB.

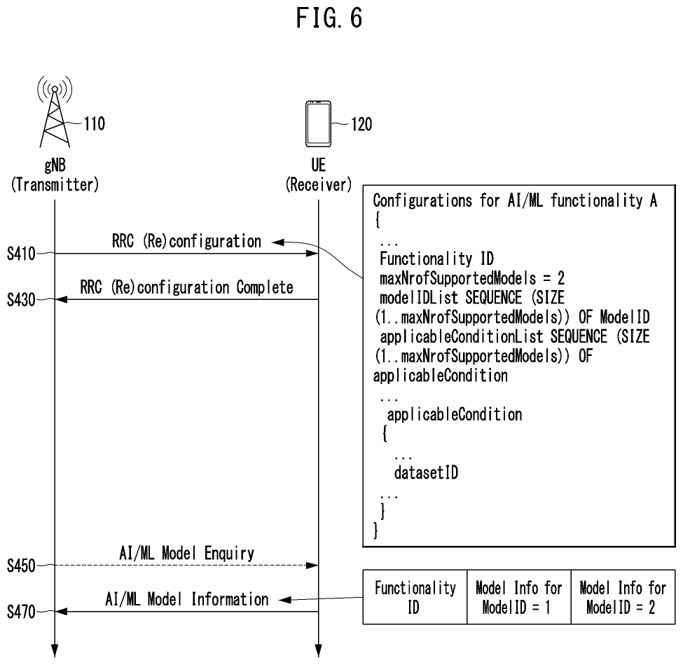

FIG. 6 is a conceptual diagram illustrating the process of delivering the AI/ML model conditions of the gNB (or base station) and reporting the model information of the UE according to an embodiment of the present invention.

Referring to FIG. 6, in the proposed method according to the embodiment of the present invention, the gNB may set the maximum number of AI/ML models to be operated for the specific functionality to the UE within the AI/ML functionality A configuration delivered in operation S410, and pre-allocate the model-ID (or order) information regarding the models within the (maximum) number.

Thereafter, the UE may report the AI/ML model information within the (maximum) number of AI/ML models to be operated, for example, in operation S470. In this case, the AI/ML model(s) to be operated by the gNB may be based on specific application conditions. For example, the gNB may operate the plurality of AI/ML models for the specific function, but operate each AI/ML model to be specialized for the specific scenario/region. For example, as illustrated in FIG. 6, two AI/ML models are specifically set, and it is possible to operate one AI/ML model to be suitable for an outdoor environment and the other AI/ML model to be suitable for an indoor environment.

Therefore, in the present invention, when the UE may report one or more AI/ML model information regarding the specific functionality to the gNB, the gNB may set the (maximum) number of AI/ML models to be operated for the specific functionality to the UE as N numbers, and the model-ID (or order) information regarding the N AI/ML model(s) is allocated, a method of informing the UE of the condition(s) of the AI/ML models to be operated for each model-ID (or order) may be proposed.

For example, the gNB may be configured to report the model information regarding the plurality of AI/ML models to the UE and may pre-allocate the identifier (or order) information for each model. In addition, the region/scenario information (e.g., outdoor and Indoor) separated from each other for each model-ID (or order) may be set as the conditions of the model to be operated. When there is the model trained for the corresponding region/scenario, the UE may report the AI/ML model information regarding the corresponding model-ID (or order) to the gNB. The AI/ML model information may include whether to support the models, the global identifiers for the models, etc. In other words, the gNB delivers the reporting conditions for each model-ID (or order) to the UE along with the pre-allocated model-ID (or order) information, and the UE may report the model information that meets the conditions. When the gNB provides the information regarding the AI/ML model to be operated for the specific model-ID (or order) information, the UE may omit the reporting model information for the corresponding model.

The above [Embodiment 07 of Proposed Method] may be applied along with other embodiment(s) of proposed method of the present invention within the range that it does not conflict with Embodiment 07 of Proposed Method.

### Embodiment 08 of Proposed Method

In mobile communication systems including a gNB and one or more UEs according to an embodiment of the present invention, when the UE may report AI/ML model information regarding a specific AI/ML functionality to the gNB and inform the UE of conditions of AI/ML models to be operated by the gNB, a method that includes at least one of the following conditions is proposed.
(1) Paired gNB (or network)-side model information (or identification information regarding the corresponding model)
(2) Dataset Identification Information
(3) Network Configuration Information

Here, when reporting the AI/ML model information, the UE may report the AI/ML model that satisfies the condition(s) set by the gNB.

Here, the dataset identification information is identification information for dividing scenarios/regions, etc., and the gNB may set the dataset identification information to physical channel and resources received by the UE. The proposed invention may also be established by replacing the dataset identification information with the scenario/region identification information.

In the mobile communication systems including a gNB and one or more UEs according to the embodiment of the present invention, it is assumed that the UE may report the AI/ML model information supported for the specific functionality to the gNB. In this case, the gNB may deliver the conditions of the AI/ML model(s) to be operated by the gNB to the UE, and the UE may report only the information regarding the AI/ML model(s) that meet the corresponding condition(s) to the gNB. The condition(s) of the AI/ML model to be operated by the gNB may include various types of information, and may include, for example, the gNB (or network)-side model information (or identification information regarding the corresponding model) paired with the UE-side AI/ML model, the dataset identification information to divide between the scenarios/regions, the network configuration information, etc. More specifically, assume that the gNB and the UE support the CSI compression use cases by utilizing the AI/ML-based encoder and decoder (e.g., Autoencoder). In the above example, the gNB may wish to operate the plurality of AI/ML models depending on an uplink control information (UCI) payload size to be supported by the gNB.

For example, the gNB may set the (maximum) number of AI/ML models to be operated for the CSI compression to 3 and set the UCI size U(n) for each nth AI/ML model order. The gNB may set the U(n) as the conditions for each nth AI/ML model order and deliver the set U(n) to the UE, and then the UE may report the AI/ML model (e.g., AI/ML-based encoder) information supporting the UCI size as much as the U(n) for each nth AI/ML model order to the gNB. As described above, the gNB may specify the conditions of the models to be operated by the gNB and instruct the UE to report the AI/ML model optimized for the corresponding condition, and the conditions of the model may be e conditions for the region/environment/environment, etc., for applying the AI/ML model.

The above [Embodiment 08 of Proposed Method] may be applied along with other embodiment(s) of proposed method of the present invention within the range that it does not conflict with Embodiment 08 of Proposed Method.

### Embodiment 09 of Proposed Method

In mobile communication systems including a gNB and one or more UEs according to an embodiment of the present invention, when the UE may report one or more AI/ML model information regarding a specific functionality to the gNB, a method is proposed in which the UE reports the model-ID (or order) information pre-allocated from the gNB to the gNB along with the AI/ML model information.

Here, the model-ID (or order) information may be explicitly delivered by the gNB to the UE or determined in a pre-arranged manner between the gNB and the UE without the explicit delivery process.

Here, the gNB may regard the pre-allocated model-ID as a valid model-ID only when the gNB provides the models or the UE provides the models. Thereafter, the gNB may use only the valid model-IDs at the LCM of the AI/ML models.

Here, characteristically, the one model-ID (or order) may correspond to only one type among a UE-side AI/ML model, a gNB-only AI/ML model, and a two-sided AI/ML model. For example, one piece of model-ID (or order) information may not be used to indicate different AI/ML model types.

In the mobile communication systems including a gNB and one or more UEs according to the embodiment of the present invention, it is assumed that the UE may report the AI/ML model information supported for the specific functionality to the gNB. In the proposed method according to an embodiment of the present invention, the gNB may set the (maximum) number of AI/ML models to be operated for a specific functionality before receiving model information from the UE, and allocate (i.e., pre-allocate) the model-ID (or order) information that may distinguish the (maximum) number of AI/ML models, followed by receiving a report on the model information from the UE. The pre-allocated model-ID (or order) information may be intermediation information for the gNB and the UE to identify the models.

For example, when the UE wishes to deliver the AI/ML model information to the gNB, the UE may inform the gNB of which model-ID (or order) information the AI/ML model information corresponds to. Accordingly, the present invention proposes a method in which the UE reports the model-ID (or order) information pre-allocated from the gNB to the gNB along with the AI/ML model information when the UE may report one or more AI/ML model information regarding the specific functionality to the gNB. According to the proposed method, the UE may flexibly report the model information regarding the plurality of AI/ML models to the gNB. The meaning of the flexible reporting may mean that the UE does not transmit the model information regarding the plurality of AI/ML models at once, but transmit the model information multiple times. For example, the UE may transmit information regarding an AI/ML model having model-ID 0 and an AI/ML model having model-ID 1 to the gNB at one time, first report AI/ML model No. 0 and then AI/ML model No. 1, or first report the AI/ML model No. 1 and then report the AI/ML model No. 0. In addition, when the gNB specifies the conditions of the model that the gNB wishes to operate for each model-ID (or order) information to the UE, the UE may inform the gNB which conditions the corresponding AI/ML model satisfies by reporting the model information and corresponding model-ID (or order) information together.

The above [Embodiment 09 of Proposed Method] may be applied along with other embodiments(s) of proposed method of the present invention within the range that it does not conflict with Embodiment 09 of Proposed Method.

### Embodiment 10 of Proposed Method

In mobile communication systems including a gNB and one or more UEs according to an embodiment of the present invention, in a method of determining a model-ID for an AI/ML model at a UE side, a method of matching a global model-ID at the UE side and a local model-ID at a gNB (or network) side using one or more of the following methods is proposed.
(1) Method 1: the gNB (or network) sets the local model-ID, and the UE reports the global model-ID corresponding to the local model-ID
(2) Method 2: the UE reports the global model-ID, and the gNB (or network) sets the local model-ID corresponding to the global model-ID

Here, the UE may report the global model-ID to the gNB (or network) through the UE capability reporting process and/or the higher layer signal transmit process after the UE capability reporting process.

In the mobile communication systems including a gNB and one or more UEs according to an embodiment of the present invention, when the UE may utilize the AI/ML models for mobile communication, for the UE-side AI/ML model, the levels of the model-ID set by the UE and the model-ID set by the gNB may be different. For example, the UE may manage the corresponding AI/ML model by allocating the global model-ID to the UE-side AI/ML model. The global model-ID may refer to the identifier that serves as a unique identifier for the AI/ML model. On the other hand, from the gNB (or network) perspective, the local model-ID may be allocated to identify the model within the area serving the UE. The global model-ID at the UE side and the local model-ID at the gNB side may have a corresponding relationship with each other.

For example, the UE reports the model information regarding the AI/ML models identified by the global model-ID to the gNB (or network), and the gNB (or network) may set the local model-ID for identification at the gNB (or network) side to the AI/ML models. Alternatively, the gNB (or network) may set the local model-ID, and the UE may report the global model-ID corresponding to the local model-ID.

The above [Embodiment 10 of Proposed Method] may be applied along with other embodiment(s) of proposed method of the present invention within the range that it does not conflict with Embodiment 011 of Proposed Method.

### Embodiment 11 of Proposed Method

In a method of determining a model-ID for an AI/ML model in mobile communication systems including a gNB and one or more UEs according to an embodiment of the present invention, a method is proposed in which the gNB transmits a model-ID change request signal including a first model-ID and a second model-ID and the UE updates the model-ID corresponding to the first model-ID to the second model-ID when receiving the request signal.

Here, when there is no model-ID corresponding to the first model-ID, the UE may ignore the model-ID change request of the gNB or feed back information that there is no corresponding model-ID.

In the mobile communication system including a gNB and one or more UEs according to an embodiment of the present invention, when the gNB and/or UE may use the AI/ML model for mobile communication, the gNB and the UE may identify the specific AI/ML model through the model-ID. However, there may be cases where the model-ID assigned to the AI/ML model needs to be updated for reasons such as the operation policy or model update of the gNB (or network). Accordingly, in the method of determining a model-ID for an AI/ML model, the present invention proposes a method in which the gNB transmits the model-ID change request signal including the first model-ID and the second model-ID and the UE updates the model-ID corresponding to the first model-ID to the second model-ID when receiving the request signal. That is, the gNB may instruct the UE to update the model-ID by delivering both the non-changed model-ID and the changed model-ID.

The above [Embodiment 11 of Proposed Method] may be applied along with other embodiment(s) of proposed method of the present invention within the range that it does not conflict with Embodiment 011 of Proposed Method.

The above-described embodiments of the present invention provide a method and apparatus for identifying AI/ML functionalities/models through an AI/ML-related capability reporting procedure and an AI/ML-related model information reporting procedure in mobile communication system including a gNB and one or more UEs when a gNB and/or UE may support one or more AI/ML functionalities/models for mobile communications. The main proposals of the embodiments of the present invention may be summarized in the following four points.

First, according to an embodiment of the present invention, in the mobile communication system including the gNB and one or more UEs, when the gNB and/or UE may support one or more AI/ML functionalities/models for mobile communication, a method is proposed in which the gNB delivers dataset identification information regarding one or more datasets to the UE and the UE reports valid AI/ML-related UE capabilities for the dataset(s) corresponding to the dataset identification information to the gNB. According to the embodiment(s) of the proposed methods of the present invention, when reporting the AI/ML-related UE capabilities, the UE can only report the valid AI/ML-related UE capabilities for the dataset(s) presented by the gNB and greatly increase the signaling efficiency in the UE capability reporting procedure. In addition, the gNB may identify the AI/ML-related configurations that the UE can support through the AI/ML-related UE capabilities of the UE.

Second, in the mobile communication system including a gNB and one or more UEs according to an embodiment of the present invention, when the UE collects gNB (or network)-side AI/ML training data and reports the collected gNB (or network)-side AI/ML training data to the gNB, a method of reporting gNB (or network)-side AI/ML training data to the gNB, including identification information such as UE provider information, is proposed. According to the embodiment(s) of the proposed method of the present invention, the UE may collect and report the gNB (or network)-side AI/ML training data, and deliver the identification information when reporting the collected data to the gNB (or network).

For example, when reporting the collected data, the UE may also notify from which UE provider's UE the data is collected. According to the embodiment of the present invention, the gNB can support the AI/ML models specialized for each UE provider by training gNB (or network)-side AI/ML models with data for each UE provider. Therefore, according to the embodiment(s) of the proposed method of the present invention, it is possible to help classify and utilize the training data of the gNB (or network)-side AI/ML models more efficiently.

Third, in the mobile communication system including a gNB and one or more UEs according to the embodiment of the present invention, when the UE may report one or more pieces of AI/ML model information regarding specific functionality to the gNB and the gNB may set the (maximum) number of AI/ML models to be operated for the specific functionality to the UE as N numbers, a method of applying different life cycle management (hereinafter, referred to as LCM) operations of AI/ML functionalities/models as follows is proposed. Specifically, a method of applying function-based LCM when N=1 and applying model-ID-based LCM when N>1 is proposed.

According to the embodiment(s) of the proposed method of the present invention, the gNB (or network) may select the exemplary LCM method by controlling the (maximum) number of AI/ML models to be operated. For example, when the gNB determines that it is sufficient to operate only a single model for a specific function, the (maximum) number of AI/ML models to be operated may be set to 1 and the function-based LCM may be applied to the corresponding function. On the other hand, when the gNB determines that the plurality of models are required for the specific function, the (maximum) number of AI/ML models to be operated may be set to greater than 1 and the model-ID-based LCM may be applied to the corresponding function. As a result, it is possible for the gNB (or network) to select the exemplary LCM methods for each AI/ML function.

Fourth, in the mobile communication system including a gNB and one or more UEs according to the embodiment of the present invention, when the UE may report one or more pieces of AI/ML model information regarding the specific functionality to the gNB and the gNB may set the UE that the (maximum) number of AI/ML models to be operated for the specific functionality to the UE as N numbers, a method is proposed in which the gNB pre-allocates the model-ID (or order) information regarding the N AI/ML model(s) and the UE reports to which model-ID (or order) information the corresponding model information corresponds when reporting the model information. According to the embodiment(s) of the proposed method of the present invention, it is possible for the gNB to quickly perform the procedure for allocating the model-IDs before receiving a report on the model information of the UE. In addition, it is possible to easily identify, from the model-IDs corresponding to the model information that the UE reports, the model information regarding which operating conditions the AI/ML models correspond to.

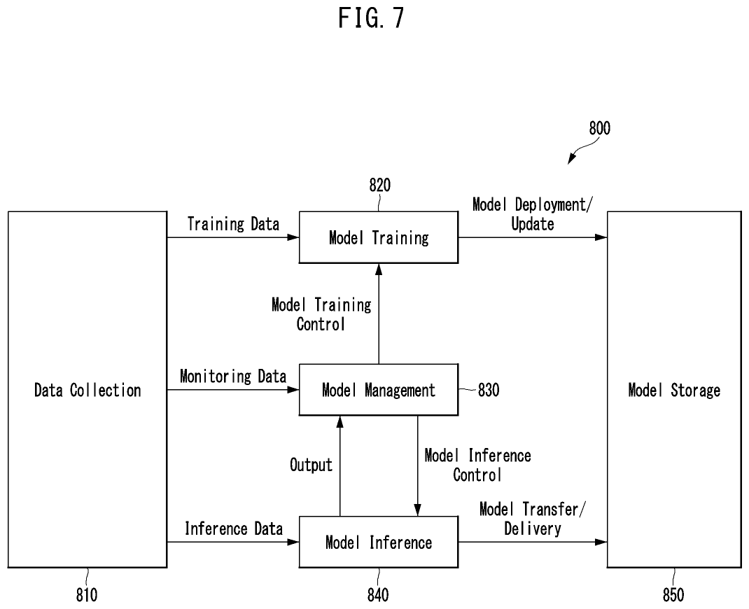

Hereinafter, the AI/ML framework will be described. FIG. 7 illustrates the AI/ML framework according to the embodiment of the present invention. The AI/ML functionalities/model(s) referenced in the embodiment(s) of the proposed method of the present invention may perform each functionality based on the AI/ML framework of FIG. 7 and may be managed as individual or integrated models.

Referring to FIG. 7, an AI/ML framework 800 may be configured to include a data collection block 810, a model training block 820, a model management block 830, a model inference block 840, and a model storage block 850. FIG. 7 is only an example of the AI/ML framework, and various entities/functionalities/blocks not disclosed in FIG. 7 may be added to the AI/ML framework, and at least some of the blocks disclosed in FIG. 7 may be omitted.

The data collection block 810 may be performed for various purposes In the LCM, such as model training, model inference, model monitoring, model selection, and model update. The data collection block 810 of FIG. 7 may be a block that conceptually represents data sources and entities that hold data for training, inference, and monitoring. Although the data collection block 810 in FIG. 7 is represented as a single block, data collection for the training, inference, and monitoring may have various characteristics and requirements. In addition, a timescale (e.g., real-time or offline, etc.) of the training and monitoring may require individual considerations.

Regarding the training, the training data may be initially generated in the network and UE. The initial data may be collected (or transmitted) to one or more data collection entities. The data collection entity may be owned by various entities such as internal entities to the network, or external entities to the network such as UE/chipset/network vendors, network operators, and positioning service providers.

Regarding the inference, inference data for the UE side model and/or the UE portion of both models may be transmitted or provided directly from the UE. The inference data for the network-side models and/or the network portion of both models may be transmitted or provided directly in the network or may be transmitted from the UE.

Regarding the monitoring, the monitoring data for the UE-side monitoring may be transferred or provided directly from the UE. The monitoring data for the network-side monitoring may be transferred or provided directly from the network, or may be transferred from the UE.

The data collection for real-time operations such as real-time model monitoring, switching, and selection may incur significant signaling overhead. Conversely, infrequent data collection to reduce the signaling overhead may cause latency for real-time model monitoring, switching, and selection.

The model training block 820 may include both the initial training and model update. In general, the model training may be divided into the model training that is performed along with model development and follow-up training for the developed model. The model training block 820 in FIG. 7 is expressed as one block for simplicity.

Depending on the location of the dataset and/or the area where the models (or untrained models) are located, the training may be performed by the internal entities to the network or by the external entities such as the UE/chipset/network vendors, the network operators, and the positioning service providers. The AI/ML model development is generally an iterative process of data collection, model design, training, and performance verification, so Power consumption, hardware area, latency, and concurrency with other layer functions need to be carefully considered for the AI/ML model development.

When large-scale field data is collected from the data collection entity, the data should be made available to a supplier responsible for model development. Generally, the model development is an offline engineering process performed by engineering teams, and needs to be performed by accessing large data sets collected in the field. That is, the determination on a model structure, device-specific optimization, and the number of models to develop (e.g., possible generalization vs. specific models) may change depending on the large-scale field data. When the supplier that owns the data collection entity is different from the supplier responsible for developing the models, the dataset should be made available to the supplier responsible for developing the models. This may be done by sharing the explicit dataset or providing the access to the collected datasets. The sharing/access of the dataset may be associated with the two-sided models where both the gNB provider and UE/chipset provider should participate in the model development and training process.

After the models are developed and trained, the models may be stored in a model repository or model storage block (X50) and delivered to a target apparatus. The models may be compiled into executable files for inference. Here, there may be various methods depending on a location where the models are trained, a model storage/delivery format, a location where the models are hosted before the models are delivered, etc.

The model inference block 840 serves to provide the AI/ML model inference output, such as prediction or determination. The model inference block 840 may provide model performance feedback to the model training block 820. The model inference block 840 may be responsible for data preparation, such as data preprocessing, cleaning, formatting, and conversion, based on the inference data delivered by the data collection block 810.

The model management may include functionality/model monitoring, selection, activation, deactivation, switching, fallback, etc. Although FIG. 7 illustrates one model management block 830, all aspects of model management may not be implemented in a single location. Some aspects of the model monitoring, activation/deactivation, selection, switching, and fallback may be performed on the network side, and other aspects may be performed on the UE side. Regarding the model selection, the activation, the deactivation, the switching, and the fallback for the UE-side models and two-sided models, mechanism related to decisions by the network is initiated by the network, mechanism related to decision by the network that is initiated by the UE and requested to the network, mechanism related to decision by the UE that is event-triggered by the network and where the decision of the UE is reported to the network, mechanism related to decision by the UE that is UE-autonomous and where the decision of the UE is reported to the network, mechanism related to decision by the UE that is UE-autonomous and where the decision of the UE are not reported to the network may be considered.

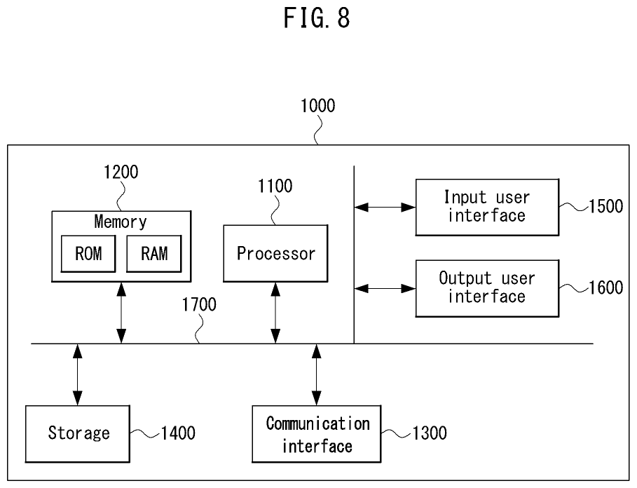

FIG. 8 is a conceptual diagram illustrating an example of a generalized computing system in which a gNB (or base station) and/or a UE in mobile communication systems capable of performing at least part of the processes of FIGS. 1 to 7 are implemented.

At least some processes of the method of identifying and managing AI/ML functionalities and/or models supported for mobile communication according to an embodiment of the present invention may be executed by a computing system 1000 of FIG. 8.

Referring to FIG. 8, the computing system 1000 according to an embodiment of the present invention may be configured to include a processor 1100, a memory 1200, a communication interface 1300, a storage device 1400, an input interface 1500, an output interface 1600, and a bus 1700.

The computing system 1000 according to the embodiment of the present invention may include at least one processor 1100 and the memory 1200 storing instructions instructing the at least one processor 1100 to perform at least one operation. At least some operations of the method according to the embodiment of the present invention may be performed by the at least one processor 1100 that loads instructions from the memory 1200 and executes the instructions.

The processor 1100 may mean a central processing unit (CPU), a graphics processing unit (GPU), or a dedicated processor on which the methods according to the embodiments of the present invention are performed.

Each of the memory 1200 and the storage device 1400 may include at least one of a volatile storage medium or a non-volatile storage medium. For example, the memory 1200 may include at least one of read only memory (ROM) and random access memory (RAM).

In addition, the computing system 1000 may include the communication interface 1300 that performs communication through a wireless network.

In addition, the computing system 1000 may further include the storage device 1400, the input interface 1500, the output interface 1600, etc.

In addition, each component included in the computing system 1000 may communicate with each other by being connected through a bus 1700.

Examples of the computing system 1000 of the present invention include a communicable desktop computer, a laptop computer, a notebook computer, a smart phone, a tablet personal computer (PC), a mobile phone, a smart watch, a smart glass, an e-book reader, a portable multimedia player (PMP), a portable game machine, a navigation device, a digital camera, a digital multimedia broadcasting (DMB) player, a digital audio recorder, a digital audio player, s digital video recorder, a digital video player, a personal digital assistant (PDA), etc.

An entity (gNB and/or UE) included in mobile communication systems according to an embodiment of the present invention includes the memory 1200 that stores at least one instruction and the processor 1100 that performs the at least one instruction. The processor 1100 may perform a method of identifying and managing AI/ML functionalities/models of the present invention by executing at least one instruction.

According to the embodiment of the present invention, when reporting the AI/ML-related UE capabilities, the UE can only report the valid AI/ML-related UE capabilities for the dataset(s) presented by the gNB and greatly increase the signaling efficiency in the UE capability reporting procedure. In addition, the gNB can identify the AI/ML-related configurations that the UE can support through the AI/ML-related UE capabilities of the UE.

According to the embodiment of the present invention, when reporting the collected data, the UE can also notify from which UE provider's UE the data is collected. According to the embodiment of the present invention, the gNB can support the AI/ML models specialized for each UE provider by training gNB (or network)-side AI/ML models with data for each UE provider. Therefore, according to the embodiment of the present invention, it is possible to help classify and utilize the training data of the gNB (or network)-side AI/ML models more efficiently.

According to the embodiment of the present invention, when the gNB determines that it is sufficient to operate only a single model for a specific function, the (maximum) number of AI/ML models to be operated can be set to 1 and the function-based LCM can be applied to the corresponding function. On the other hand, when the gNB determines that the plurality of models are required for a specific function, the (maximum) number of AI/ML models to be operated can be set to greater than 1 and the model identifier (model-ID)-based LCM can be applied to the corresponding function. As a result, it is possible for the gNB (or network) to select the exemplary LCM methods for each AI/ML function.

According to the embodiment of the present invention, it is possible for the gNB to quickly perform the procedure for assigning the model-IDs before receiving a report on the model information of the UE. In addition, it is possible to easily identify, from the model-IDs corresponding to the model information that the UE reports, the model information regarding which operating conditions the AI/ML models correspond to.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. A part or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform a part or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of identifying an artificial intelligence (AI)/machine learning (ML) functionality and model supported for mobile communication operated in a mobile communication system including a base station and one or more user equipments (UEs), the method comprising:
delivering, from the base station, dataset identification information regarding at least one dataset to the UE; and
reporting, by the UE, valid AI/ML-related UE capability for the at least one dataset corresponding to the dataset identification information to the base station.

2. The method of claim 1, wherein the delivering of, from the base station, the dataset identification information regarding the at least one dataset to the UE includes requesting, from the base station, AI/ML-related UE capability reporting to the UE, and
in the reporting of, by the UE, the valid AI/ML-related UE capability, the UE reports the valid AI/ML-related UE capability for the at least one dataset corresponding to the dataset identification information to the base station in response to the requested AI/ML-related UE capability reporting.

3. The method of claim 1, wherein the delivering of, from the base station, the dataset identification information regarding the at least one dataset to the UE includes requesting, from the base station, AI/ML-related UE capability reporting to the UE, and
the dataset identification information is delivered by being included in a signal requesting the AI/ML-related UE capability reporting.

4. The method of claim 1, further comprising determining, by the UE, validity of AI/ML-related UE capability for the at least one dataset corresponding to the dataset identification information,
wherein, in the determining of, by the UE, the validity of the AI/ML-related UE capability, the UE determines the validity of the AI/ML-related UE capability for at least one of the at least one dataset corresponding to the dataset identification information or a test set corresponding to the at least one dataset based on whether the AI/ML-related UE capability satisfies a predetermined performance criterion.

5. The method of claim 1, wherein the dataset identification information includes at least one of scenario information or region information to which the at least one dataset is related.

6. The method of claim 1, wherein, in the reporting of, by the UE, the valid AI/ML-related UE capability, the AI/ML-related UE capability includes at least one of data collection, model training, model inference operation, model deployment, model activation, model deactivation, model selection, model monitoring, or model transfer.

7. The method of claim 1, further comprising:
collecting, by the UE, data for a base station-side AI/ML model or network-side AI/ML model; and
reporting, by the UE, the collected data to the base station.

8. The method of claim 7, further comprising implementing, by the base station, the AI/ML model by classifying and utilizing the collected data for each of identification information regarding the collected data,
wherein, in the reporting of, by the UE, the collected data to the base station, at least one of the dataset identification information, UE provider identification information, or functionality identification information is reported as the identification information regarding the collected data along with the collected data.

9. A mobile communication system using an artificial intelligence (AI)/machine learning (ML) functionality and model, comprising a base station and one or more user equipments (UEs),
the base station is configured to set a number of AI/ML models to be operated for a specific functionality to the UE, and
the UE is configured to report information regarding supportable AI/ML models less than or equal to the set number.

10. The mobile communication system of claim 9, wherein, when the set number is 1 and the UE reports information regarding the supportable AI/ML models, the UE reports whether to support the specific functionality.

11. The mobile communication system of claim 9, wherein, when the set number is 2 or more and the UE reports the information regarding the supportable AI/ML models, the UE reports both a functionality identifier corresponding to the specific functionality and at least one AI/ML model identifier corresponding to the specific functionality.

12. The mobile communication system of claim 9, wherein the base station and the UE perform a life cycle management (LCM) operation of the AI/ML functionality and model using an operation technique determined based on the set number.

13. The mobile communication system of claim 12, wherein, when the set number is 1, a function-based LCM technique is applied.

14. The mobile communication system of claim 12, wherein, when the set number is 2 or more, the model identifier-based LCM technique is applied.

15. A method of identifying artificial intelligence (AI)/machine learning (ML) functionality and model supported for mobile communication operated in a mobile communication system including a base station and one or more user equipments (UEs), the method comprising:
setting, by the base station, a number N of AI/ML models to be operated for a specific functionality to the UE;
pre-allocating, by the base station, at least one of model identifiers or order information for N AI/ML models to be operated for the specific functionality; and
reporting, by the UE, information regarding supportable AI/ML models less than or equal to N based on the at least one of the pre-allocated model-ID or the order information.

16. The method of claim 15, further comprising:
determining, by the base station, whether to provide an AI/ML model to the UE in response to a part or all of the at least one of the pre-allocated model identifiers or the order information; and
determining, by the base station, whether to report the information regarding the supportable AI/ML models of the UE in response to the at least one of the pre-allocated model identifiers or the order information.

17. The method of claim 15, further comprising providing, by the base station, a condition of an AI/ML model to be operated to the UE in response to the at least one of the pre-allocated model identifiers or the order information,
wherein, in reporting, by the UE, the information regarding the supportable AI/ML models, whether to support the at least one of the pre-allocated model-ID or the order information is included in the information regarding the AI/ML model and reported.

18. The method of claim 15, further comprising providing, by the base station, a condition of an AI/ML model to be operated to the UE,
wherein the condition of the AI/ML model includes at least one of identification information, dataset identification information, or network configuration information regarding the base station-side model or network-side model paired with the UE.

19. The method of claim 15, further comprising:
setting, by the base station, a local model identifier; and
reporting, by the UE, a global model identifier,
wherein when the base station first sets the local model identifier, and the UE reports the global model identifier corresponding to the local model identifier, and
when the UE first reports the global model identifier, the base station sets the local model identifier corresponding to the global model identifier.

20. The method of claim 15, further comprising:
transmitting, from the base station, a model identifier change request signal including a first model identifier and a second model identifier to the UE;
updating, by the UE, a model identifier corresponding to the first model identifier to the second model identifier based on the model identifier change request signal; and
when the UE does not have a model identifier corresponding to the first model identifier, feeding back an absence of the model identifier corresponding to the first model identifier to the base station.
